(19) United States
(12) Patent Application Publication
(10) Pub. No.: US 2010/0218106 A1
(43) Pub. Date: Aug. 26, 2010

(54) Automatically Selecting Internet Browser and Providing Web Page Service

(75) Inventors: Rebecca L.J. Chen, Taipei (TW); Leo C.Y. Kuo, Taipei (TW); Uriel K.L. Liu, Taipei (TW); Rick M.F. Wu, Taipei (TW); Cecelia Y.C. Yu, Taipei (TW)

Correspondence Address: MARCIA L. DOUBET LAW FIRM, PO BOX 422859, KISSIMMEE, FL, 34742, US

(73) Assignee: INTERNATIONAL BUSINESS MACHINES CORPORATION, Armonk, NY (US)

(21) Appl. No.: 12/702,815

(22) Filed: Feb. 9, 2010

(30) Foreign Application Priority Data
Feb. 24, 2009 (TW) 98105874

(51) Int. Cl. G06F 3/048

(52) U.S. Cl. 715/738; 715/760

(57) ABSTRACT

Automatically selecting a browser and providing a web page service. In one embodiment, this comprises: sending a request to a server; receiving a web page from the server; determining whether the web page has at least one preference tag; selecting a preferred browser according to the at least one preference tag; and initiating the preferred browser.

### CROSS REFERENCE TO RELATED APPLICATIONS

This application claims priority of Taiwan Patent Application Serial No. 98105874 entitled “DEVICE, METHOD AND COMPUTER PROGRAM PRODUCT FOR AUTOMATICALLY SELECTING INTERNET BROWSER AND PROVIDING WEB PAGE SERVICE”, filed on Feb. 24, 2009.

### BACKGROUND OF THE INVENTION

The present invention relates to automatically selecting an internet browser and providing a web page service, and more particularly to automatically selecting an internet browser by using a preference tag embedded in the web page.

Internet has become an important technology as a platform for the purpose of work, play, social, advertisement, and many other activities. As the Internet becomes more and more powerful, the technical structure and relationship between service providers also become more and more complicated. For example, AJAX is a newly developed technology to provide various applications over the Internet. AJAX, abbreviated from “Asynchronous JavaScript and XML,” is a web technology for developing interactive web applications which utilizes JavaScript® for sending standardized requests in Extensible Markup Language (“XML”) format to, and receiving responses from, the web server in order to implement asynchronous data exchange. (“JavaScript” is a registered trademark of Sun Microsystems, Inc. in the United States, other countries, or both.) By means of AJAX, the data processing may be partially transferred to the client from the server, which significantly relieves the workload on the server side and accelerates the data processing.

For the diversity of browsers, some developers try to solve this issue by adopting multiple versions for a single web page in order to maintain the performance on different browsers. When the user requests a web page, the server will provide the specific version for the user's browser. However, it raises the development cost and is unaffordable for small and medium sized companies. Contrarily, some developers will only maintain one version of a web page for a specific browser, also known as an “IE Only” or a “Firefox Only” page. In this circumstance, users may get a poor display or an error message such as “the browser you used is not compatible with this page” if the wrong browser is used. Therefore, the user needs to initiate another browser, or even install a new one, and repeat the procedures to load the web page. Although it reduces the development cost, it creates another problem that the browsing experience is annoying and frustrating to the user.

On the other hand, software developers may develop their own browser in order to provide different characteristics and functions, such as the Internet Explorer® from Microsoft, Firefox® from Mozilla Foundation, Safari® from Apple Computer, Opera® from Opera Software, etc. (“Internet Explorer” is a registered trademark of Microsoft Corporation in the United States, other countries, or both. “Firefox” is a registered trademark of Mozilla Foundation in the United States, other countries, or both. “Safari” is a registered trademark of Apple Inc. in the United States, other countries, or both. “Opera” is a registered trademark of Opera Software ASA Corporation in the United States, other countries, or both.) Moreover, developers may provide updates to their browsers frequently in order to enhance their competitiveness or fix bugs in the earlier version. In addition to browser developers, other application providers also try to develop new applications to catch the consumers' eye. For example, Flash® player and Acrobat® reader are respectively a multimedia player and a document viewer commonly used on the Internet. (“Flash” and “Acrobat” are registered trademarks of Adobe Systems Incorporated in the United States, other countries, or both.) Such kind of applications is usually released in the form of a plug-in to enhance the functions of browsers. To update the plug-ins in the browsers becomes a difficult job for the user.

It becomes a difficult job to maintain both the plug-ins and browsers in the most updated versions even for a professional technician, not to mention a general consumer. Most of the time, the only solution is to repeatedly try different browsers and/or plug-ins and get an acceptable result after a lot of trial and error. Even worse, when the user is surfing from one web page to another, he may again repeat the entire trial-and-error process, which may be annoying for the user.

Therefore, it is advantageous to provide for automatically selecting the browser in order to provide a friendly and convenient browsing environment.

### SUMMARY OF THE INVENTION

In one aspect, the present invention comprises automatically selecting a browser to access a web page by: determining whether the web page has at least one preference tag; selecting a preferred browser from a plurality of browsers according to the at least one preference tag; and (optionally) initiating the preferred browser.

In another aspect, the present invention comprises providing a web page service. This preferably comprises: determining at least one preference setting for a web page; receiving a request for the web page; embedding the at least one preference setting in the web page as a preference tag; and returning the web page. The web page may be dynamically generated upon receiving the request, and the preference setting may correspond to the generated web page.

Embodiments of these and other aspects of the present invention may be provided as methods, systems (apparatus), and/or computer program products. Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings

FIG. 1 is an exemplary diagram of a system according to an embodiment of the present invention;

FIG. 2 is an exemplary diagram of a client according to an embodiment of the present invention;

FIG. 3 illustrates a block diagram of a system according to an embodiment of the present invention;

FIG. 4 is a flowchart illustrating a method according to one embodiment of the present invention;

FIG. 5 is a flowchart illustrating a method according to another embodiment of the present invention;

FIG. 6 is a flowchart illustrating a method according to yet another embodiment of the present invention;

FIG. 7 is a flowchart illustrating a method according to still another embodiment of the present invention;

FIG. 8 illustrates an exemplary embodiment of a preference tag according to one embodiment of the present invention;

FIG. 9 illustrates an exemplary embodiment of a preference tag according to another embodiment of the present invention;

FIG. 10 is an exemplary diagram of a user interface according to an embodiment of the present invention; and

FIG. 11 is an exemplary diagram of a user interface according to another embodiment of the present invention.

### DETAILED DESCRIPTION OF THE PREFERRED EMBODIMENTS

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the present invention may take the form of a computer program product embodied in any tangible medium having computer-usable program code embodied in the medium.

Any combination of one or more computer usable or computer readable media may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device. In the context of this document, a computer-usable or computer-readable medium may be any tangible medium that can contain or store, the program for use by or in connection with the instruction execution system, apparatus, or device.

Computer program code for carrying out operations of the present invention may be written in any combination of one or more programming languages, including an object oriented programming language such as Java®, Smalltalk, C++ or the like and conventional procedural programming languages, such as the “C” programming language or similar programming languages. (“Java” is a registered trademark of Sun Microsystems, Inc. in the United States, other countries, or both.) The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

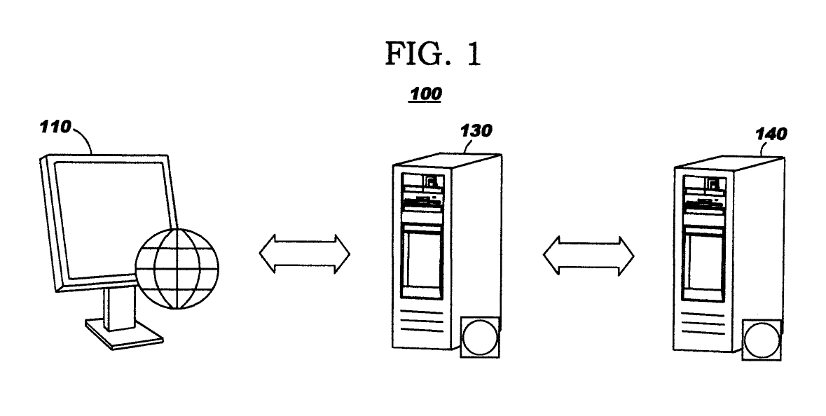

Referring now to FIG. 1 through FIG. 11, devices, methods, and computer program products are illustrated as structural or functional block diagrams or process flowcharts according to various embodiments of the present invention. The flowchart and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

FIG. 1 is an exemplary diagram of a system according to an embodiment of the present invention. In this exemplary embodiment, system 100 includes a client 110, web server 130, and application server 140, which may be coupled and communicated by any hardware structures or software protocols, such as Internet structure and TCP/IP protocols, or any other communication techniques. Application server 140 may be another web server in one embodiment or a database server in another embodiment, or any other server providing network services. Therefore, those skilled in the art should understand that the present invention should not be limited to either specific services provided by the servers or to a specific number of servers. The detailed descriptions herein are illustrated for exemplary purposes in order to enable those skilled in the art to clearly understand the present invention. For example, the so-called web server 130 and application server 140 are named for convenience and illustrative purposes, depending on whether they directly receive and/or reply to requests from client 110. In other embodiments, client 110 may issue a request directly to application server 140.

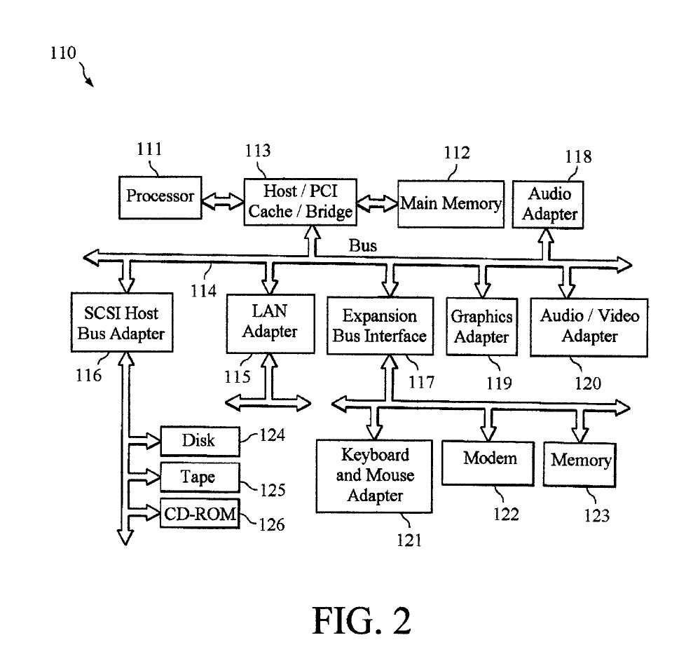

The client 110, web server 130, and application server 140 may be embodied as a computer according to one embodiment of the present invention. For example, FIG. 2 is an exemplary block diagram of client 110 according to one embodiment of the present invention. In this example, client 110 is a general-purpose computer, in which code or instructions implementing processes of the present invention may be located. Client 110 employs a peripheral component interconnect (PCI) local bus architecture. Although the depicted example employs a PCI bus, other bus architectures such as Accelerated Graphics Port (AGP) and Industry Standard Architecture (ISA) may be used. Processor 111 and main memory 112 are connected to PCI local bus 114 through PCI bridge 113. PCI bridge 113 also may include an integrated memory controller and cache memory for processor 111. Additional connections to PCI local bus 113 may be made through direct component interconnection or through add-in boards.

In the depicted example, local area network (LAN) adapter 115, small computer system interface (SCSI) host bus adapter 116, and expansion bus interface 117 are connected to PCI local bus 114 by direct component connection. In contrast, audio adapter 118, graphics adapter 119, and audio/video adapter 120 are connected to PCI local bus 114 by add-in boards inserted into expansion slots. Expansion bus interface 117 provides a connection for a keyboard and mouse adapter 121, modem 122, and additional memory 123. SCSI host bus adapter 116 provides a connection for hard disk drive 124, tape drive 125, and CD-ROM drive 130. Typical PCI local bus implementations will support three or four PCI expansion slots or add-in connectors.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system. For example, client 110, if optionally configured as a network computer, may omit SCSI host bus adapter 116, hard disk drive 124, tape drive 125, and CD-ROM 126. In that case, the computer, to be properly called a client computer, includes some type of network communication interface, such as LAN adapter 115, modem 122, or the like. As another example, client 110 may be a stand-alone system configured to be bootable without relying on some type of network communication interface, whether or not client 110 comprises some type of network communication interface. As a further example, client 110 may be a personal digital assistant (PDA), which is configured with ROM and/or flash ROM to provide non-volatile memory for storing operating system files and/or user-generated data. The depicted example in FIG. 2 and above-described examples are not meant to imply architectural limitations.

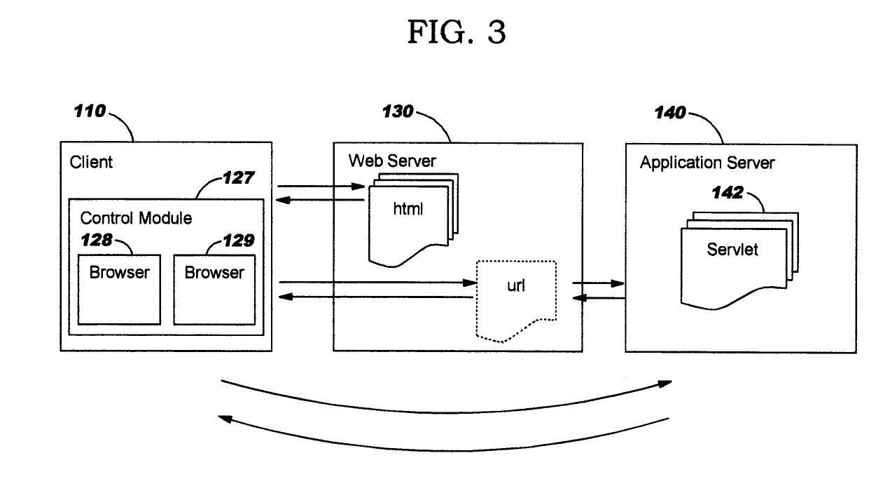

FIG. 3 further illustrates a block diagram of a system according to an embodiment of the present invention. An operating system runs on processor 111 and is used to coordinate and provide control of various components within client 110. The operating system may be a commercially available operating system such as Windows XP®. (“Windows XP” is a registered trademark of Microsoft Corporation in the United States, other countries, or both.) An object oriented programming system such as Java may run in conjunction with the operating system and provides calls to the operating system from Java programs or applications executing on client 110. Instructions for the operating system, the object-oriented programming system, and applications or programs are located on storage devices, such as hard disk drive 124, and may be loaded into main memory 112 for execution by processor 111 in order to provide the functions of control module 127, browser 128, browser 129, and so forth. In this embodiment, control module 127 is capable of providing an integrated browsing environment, such as Symphony™ provided by International Business Machines Corporation (“IBM”). After the control module 127 is executed, it may obtain information pertaining to browsers, such as browsers 128 and 129, in whole or in part, from the operating system. Notably, more or fewer browsers may be installed in other embodiments. The browser information obtained by control module 127 may include the version of browser; the path to locate the executable file; the JavaScript capability; the quantity, type, version, and description of the installed plug-ins for the browser; and the like. Alternatively, control module 127 may scan the entire environment to locate all available browsers, such as detecting by program name or identification code to determine whether there is any browser unregistered to the operating system, such as portable browsers.

In this embodiment, the web server 130 may determine whether the web page requested by a user through the client 110 is a static page or a dynamically-linked page. Those skilled in the art may understand this embodiment by taking some hypothetical scenarios as examples. In the first hypothetical scenario, when the web server 130 determines that the requested web page is static and stored therein, it returns the requested web page to client 110 as a response. Once the client 110 receives the web page returned by the server 130, the control module 127 may interpret a preference tag, if any, embedded in the web page in order to determine whether there is any browser in client 110 suitable for handling the web page. In this scenario, if the control module 127 determines that browser 128 is the most suitable browser to handle the web page, it then initiates the browser 128 to handle and present the web page to the user who requested the web page. The user may therefore obtain the best browsing experience without manually making any judgment or selection. In the second hypothetical scenario, the user clicks another link in the web page handled by browser 128 and a new request is sent by control module 127 to web server 130. When the web server 130 determines that the second web page requested by the user is dynamically-linked and located on application server 140, it may send a request to the application server 140. The application server 140 dynamically generates the content of the web page by a service module 142 (illustrated in FIG. 3 as a servlet) and then returns the web page to the web server 130. The web server 130 then sends the web page to the client 110. If the control module 127 determines that browser 129 is the most suitable browser to handle the second web page, it will automatically initiate browser 129 instead of browser 128 to handle the second web page. Therefore, the user may again obtain the best browsing experience without manually switching between browsers 128 and 129. This is referred to herein as “seamless browsing”.

Also, client 110 may directly send a request to application server 140 or other different processing sequences without affecting the performance of the present invention.

It should be noted that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and/or across several memory devices. Similarly, operational data may be identified and illustrated herein within modules, and may be embodied in any suitable form and organized within any suitable type of data structure. The operational data may be collected as a single data set, or may be distributed over different locations including over different storage devices.

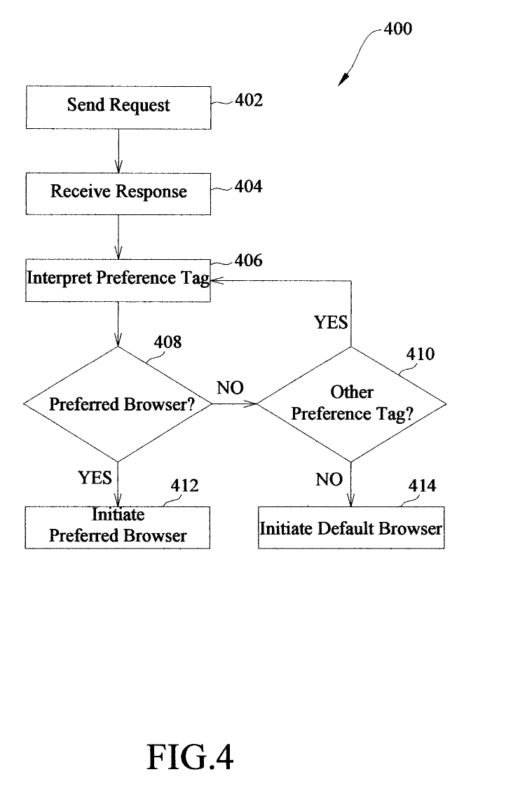

Referring now to FIG. 4 to FIG. 6, these figures provide flowcharts illustrating processes in client 110, web server 130, and application server 140 according to one embodiment of the present invention.

FIG. 4 is a flowchart illustrating processing performed in client 110 according to one embodiment of the present invention. The method 400 begins at Block 402, wherein a user sends a request through client 110 to the web server 130. When the web server 130 responds to the request, client 110 receives the web page at Block 404. In Block 406, control module 127 starts to interpret the preference tag, if any, within the web page. In this embodiment, the preference tag contains one or more preference settings assigned by a web designer or automatically generated for the web page in order to determine the most suitable browser for handling the web page. In this embodiment, the preference settings may be categorized into two types. The first type is an identification directly indicating the preferred browser, and the second type sets the requirement(s) for handling the web page. The control module 127 may simply verify the identification of a preferred browser to determine which browser should be initiated to handle the received web page. An exemplary preference setting in the form of identification of a preferred browser is as below:

<meta name=“Browser-Preference” content=“IE; version=7.0”>

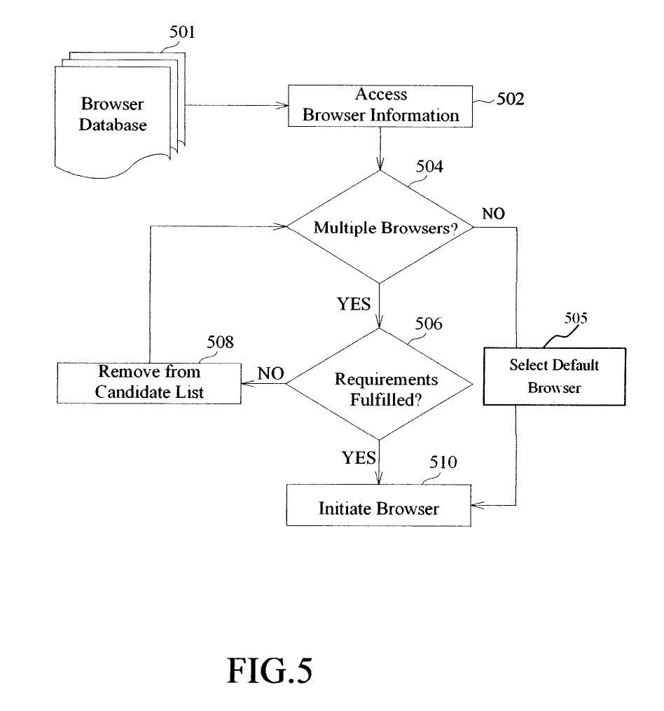

In this example, the META tag under the standard HyperText Markup Language (“HTML”) is used to implement the preference tag according to one embodiment of the present invention. When control module 127 finds that the value of the name attribute of the META tag is “Browser-Preference”, it may interpret this preference tag as an identification of a preferred browser. Also, control module 127 may conclude that the preferred browser is Internet Explorer with version 7.0 (“IE 7.0”) for the received web page. It should be noted that a web page may include more than one preferred browser. If the preference tag reveals several preferred browsers, the control module 127 may arbitrarily initiate any one of the preferred browsers. Alternatively, the preference tag may contain additional information to assign priority between the multiple preferred browsers. In Block 408, the control module 127 may further verify whether the preferred browser identified in the preference tag, such as the IE 7.0 browser in the above example, has already been registered, installed, and/or is otherwise available in the operating system. If yes, the control module 127 may initiate the preferred browser, such as IE 7.0 in this example, for handling and presenting the web page to the user in Block 412. If none of the browsers installed, registered, or otherwise available in the operating system conform to the preferred browser identified in the preference tag, the process proceeds to Block 410 to determine whether there is any other preference setting or preference tag available. If yes, the process returns to Block 406 and repeats the determination of the preferred browser. (Alternatively, another process illustrated in FIG. 5 for determining a suitable browser may be used, as discussed below, according to another embodiment of the present invention.) If neither the browsers conform to the preferred browser nor any further preference setting or tag is available, the control module 127 may initiate a default browser registered in the operating system in Block 414. The default browser may be assigned by the control module 127, the operating system, or the user without any limitations to the present invention.

FIG. 5 is a flowchart illustrating processing performed in client 110 according to another embodiment of the present invention. In Block 502, the control module 127 accesses the information regarding all browsers installed or otherwise registered in the client 110 from a browser database 501, such as accessing the version of browser; the path to locate the executable file; the JavaScript capability; the quantity, type, version, and description of the installed plug-ins for the browser; and the like. The browser database 501 may be a register file provided by the operating system, a list created by the control module 127 by scanning the entire operating system, otherwise acquired by control module 127, or any combination of the above. The control module may put information regarding all available browsers in a candidate list for the following process. In this embodiment, control module 127 may determine whether there is more than one browser available in the operating system in Block 504. If only one browser is available in the operating system, the control module 127 has no other choice and selects the default browser in Block 505. If more than one browser is available, the control module 127 determines whether the capability of one of the browsers fulfills the requirement(s) set in the preference tag in Block 506. For example, if several preferred browsers are found in the operating system, the second type of preference setting may help control module 127 to further determine the most suitable browser. Some exemplary preference settings in the form of requirements for handling the web page are as below:

<meta name= “Browser-Capability” requires= “javascript;
version=2.0”>
<meta name= “Browser-Capability” requires= “flash player;
version=8.0”>
<meta name= “Browser-Capability” requires= “adobe reader;
version=7.0”>

When the control module 127 finds that the value of the name attribute of the META tag is “Browser-Capability”, it may determine that this preference tag contains preference settings identifying the requirement(s) for handling the web page. In this example, capabilities of JavaScript version 2.0, Flash Player version 8.0, and Adobe Reader version 7.0 are required to properly display the web page. These preference settings are very helpful for control module 127 to determine the most suitable browser without manual input from the user. If the browser fulfills all requirements set in the preference tag, the control module 127 may initiate such browser in Block 510. Otherwise, the control module 127 may remove such browser from the candidate list in Block 508 and repeat Blocks 504 to 506. If none of the browsers fulfills all requirements set in the preference tag, the control module 127 may initiate the browser fulfilling the most requirements as compared to other browsers, or alternatively it may initiate the default browser registered in the operating system.

It should be noted that the processing of the blocks illustrated in the drawings need not be performed in the specific sequence illustrated and some processing may be omitted in other embodiments. For example, the control module 127 may reload the information from the database 501 periodically or upon instruction by the user.

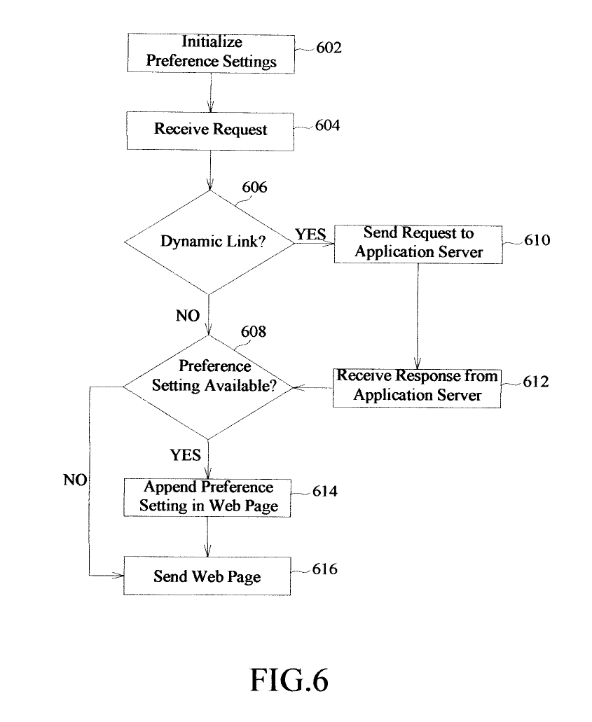

FIG. 6 is a flowchart illustrating processing performed in web server 130 according to yet another embodiment of the present invention. In Block 602, the web server 130 may initialize the preference settings in the web server 130. This processing may be performed periodically, upon boot-up, or upon additional instruction. In this embodiment, the web server 130 may create a configuration file, such as “browser.xml”, for storing the preference settings as below.

| | |
|---|---|
| /homepage/* | Firefox 3.0 |
| /user/* | Opera 9.0 |
| /administrator/* | IE 7.0 |

In this example, all files contained in the directory “homepage” have a preferred browser “Firefox 3.0.” Similarly, all files contained in the directories “user” and “administrator” respectively have preferred browsers “Opera 9.0” and “IE 7.0.” Notably, there may be more or less information contained in the configuration file for facilitating the determination of a suitable browser.

In this embodiment, web server 130 receives a web page request from the client 110 in Block 604 and determines whether the requested web page is static or dynamically-linked, i.e., whether an application server 140 is involved in the process (Block 606). For better understanding, some hypothetical scenarios are provided for illustrative purposes. In this example, suppose the user requests a file located in the directory “homepage” and the requested web page is a static file. The service module may determine whether there is any preference setting available in Block 608. Therefore, the service module in the web server 130 may determine that the preference setting is “Firefox 3.0” in this example. In a second scenario, suppose the user requests a web page located in directory “administrator” and the requested web page is dynamically linked. The service module then sends a request to application server 140 in Block 610 and receives the response from the application server 140 in Block 612. The service module may determine that the preference setting is “IE 7.0” unless additional recommendation information is found (Block 608) in the response from the application server 140. In Block 614, the service module embeds the preference setting within the web page as a preference tag and thereafter returns the web page to the client 110 in Block 616. It should be noted that Block 614 may be omitted for some cases if a particular web page does not have any corresponding preference setting. In such cases, the web page without any preference tag embedded therein will be returned to the client 110 and the client 110 may also select the proper browser by itself.

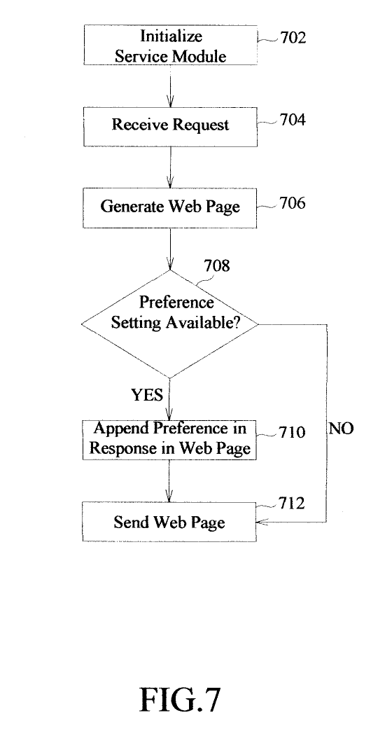

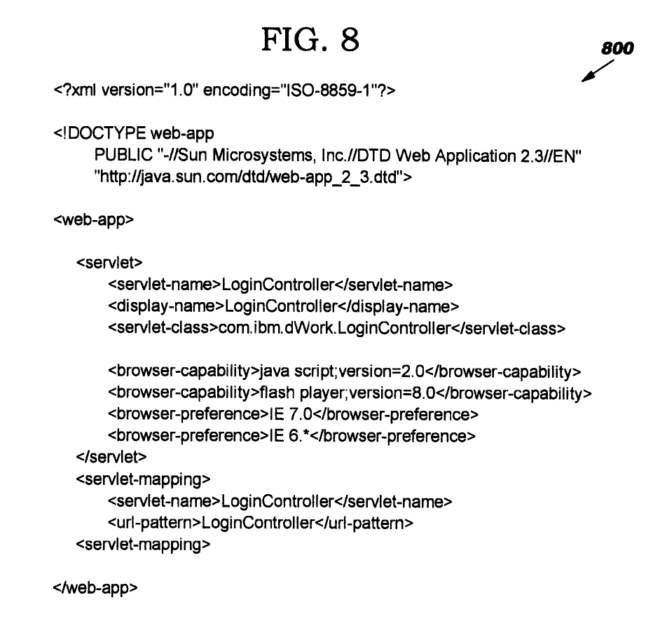

FIG. 7 is a flowchart illustrating processing performed in application server 140 according to still another embodiment of the present invention. In Block 702, the application server 140 may initialize the preference settings in the service module 142. This processing may be performed periodically, upon boot-up, or upon additional instruction. In this example, the application server 140 uses a service module 142 to dynamically define the preference settings for the web pages. For example, the service module 142 may be a “web.xml” under the standard Java Platform, Extended Edition (“Java EE”) to dynamically embed the preference tag into the header in a HyperText Transfer Protocol (“HTTP”) response. Exemplary codes are illustrated in FIG. 8.

In Block 704, the application server 140 receives a request from web server 130 or the client 110. In Block 706, the application server 140 dynamically generates a web page by the service module 142 responsive to the request. In Block 708, a determination is made whether there is any preference setting corresponding to the generated web page. If yes, the preference setting is embedded into the generated web page in Block 710 and the web page is returned to the web server 130 or the client 110 at Block 712. Otherwise, when there is no preference setting corresponding to the generated web page, Block 710 may be omitted and Block 712 then returns the original web page.

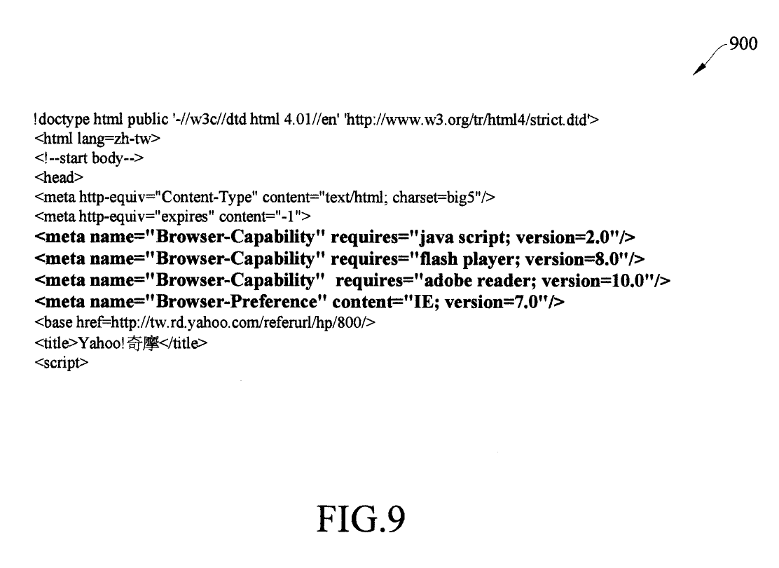

It should be noted that the above descriptions are recited for illustrative purpose rather than as limitations. The present invention may still have various amendments and/or changes. For example, the preference settings may be embedded in the HTML file prior to receiving the web page request from the client 110, as shown in FIG. 9. For another example, browsers 128 and 129 shown in FIG. 3 are depicted within the control module 127 for illustrative purpose rather than as limitations to the present invention. Below are several different embodiments between control module 127 and browsers 128 and 129.

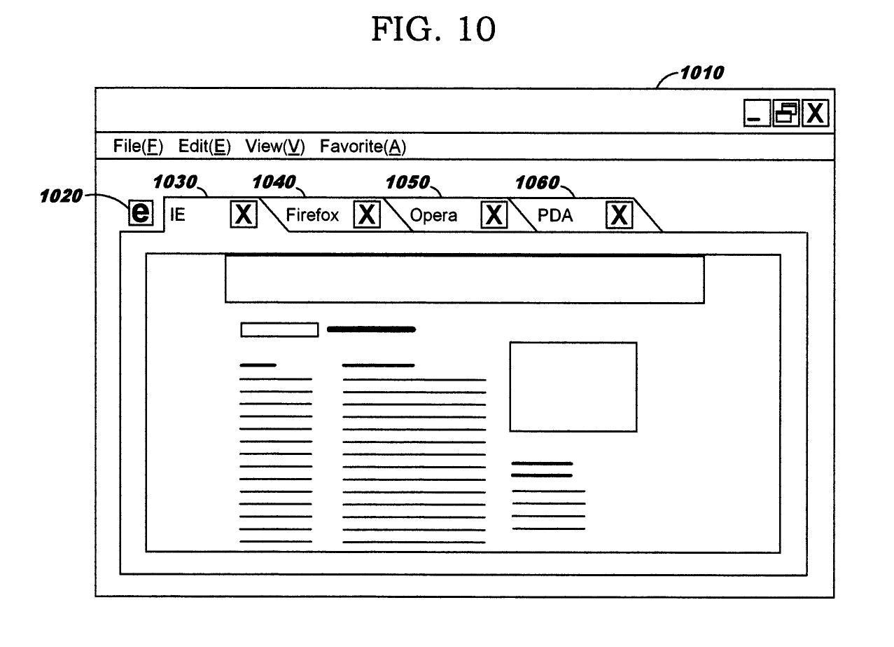

FIG. 10 is an exemplary diagram of a user interface according to an embodiment of the present invention. In this embodiment, the control module 127 is embodied as an integrated user interface 1010. When the client 110 sends requests and receives web pages from the web server 130, these web pages are displayed in pages within the integrated user interface 1010. For example, when a first page is received and the IE is selected as a suitable browser, the integrated user interface 1010 calls the IE's libraries to display the first web page in a first display page 1030. An additional indicator 1020 may be used to notify the user as to the current browser. When the user clicks a link within the displayed page 1030, the integrated user interface 1010 may receive a second web page and determine its suitable browser. Assuming that the Firefox browser is the suitable browser for the second web page, the integrated user interface 1010 then calls the Firefox's libraries to display the second web page in a second display page 1040. Similarly, the integrated user interface 1010 may initiate Opera and PDA-emulating browsers in display pages 1050 and 1060. In this embodiment, although browsers are independent from the integrated user interface 1010, the integrated user interface 1010 may provide seamless browsing to the user.

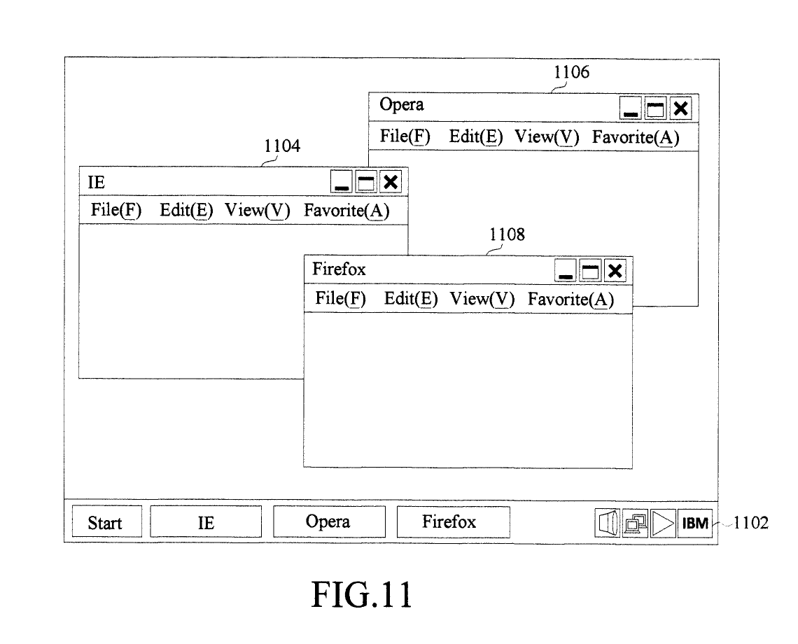

FIG. 11 is an exemplary diagram of a user interface according to another embodiment of the present invention. In this embodiment, the control module 127 is embodied as a daemon program 1102 processed in background. That is, the user may not even notice the existence of the daemon program 1102. Referring to the bottom right corner of FIG. 11, an optional icon identifying the existence of the daemon program 1102 may be used. When the client 110 requests and receives the web page from web server 130 or application server 140, the daemon program 1102 may intercept and determine the suitable browser for the received web page. For example, the user may originally use IE browser 1104 to surf the web and then click a link to request a web page. The daemon program 1102 may then automatically determine that the Opera browser is suitable for the second web page. Therefore, the daemon program 1102 may call Opera browser 1106 to handle the second web page. Similarly, the daemon program 1102 may call Firefox browser 1108 to handle a third web page. In this embodiment, seamless browsing is achieved for the user without noticing the existence of the daemon program 1102.

In addition to the embodiments illustrated in FIG. 10 and FIG. 11, there may still be various amendments and modification in other embodiments of the present invention. For example, the control module 127 may be implemented as a plug-in to a browser, such as the default browser of the operating system, or alternatively a toolbar of a browser or any other program running under the operating system. Regardless of the form of embodiment, the user may obtain the best browsing experience without wasting time on manually comparing the version, function, and other capability between various browsers and then manually selecting a specific browser in order to obtain the best browsing experience.

The above-provided description of preferred embodiments of the present invention is illustrative, and is not intended to limit the scope of the invention. Therefore, it is intended that the appended claims shall be construed to include all such variations and modifications as fall within the spirit and scope of the invention.

1. An electronic device for automatically selecting a browser to access a web page, the electronic device coupled to a server for accessing a web page, comprising:
a plurality of browsers for handling the web page received from the server; and
a module for interpreting a preference tag embedded in the web page;
wherein the module selects a browser from the plurality of browsers according to the preference tag for handling the web page.

2. The electronic device according to claim 1, wherein a browser conforming to an identification of a preferred browser in the preference tag is selected by the module and initiated.

3. The electronic device according to claim 1, wherein a default browser is selected and initiated when none of the plurality of browsers conforms to an identification of a preferred browser in the preference tag.

4. The electronic device according to claim 1, wherein the preference tag further includes a plurality of preference settings, and wherein a browser conforming to all of the preference settings in the preference tag is selected and initiated.

5. The electronic device according to claim 4, wherein a browser conforming to most preference settings, as compared to other browsers, is selected and initiated if none of the plurality of browsers conforms to all of the preference settings in the preference tag.

6. The electronic device according to claim 1, wherein the module is an integrated user interface comprising at least one page used by the selected browser to display the web page.

7. The electronic device according to claim 1, wherein the module is a daemon processed in background.

8. The electronic device according to claim 1, wherein the module is a plug-in used in at least one of the plurality of browsers.

9. The electronic device according to claim 1, further comprising a database for storing configurations corresponding to the plurality of browsers.

10. A computer-implemented method for automatically selecting a browser, comprising:
sending a request to a server;
receiving a web page from the server, responsive to the request;
determining whether the web page has at least one preference tag embedded therein;
selecting a preferred browser from a plurality of browsers according to the at least one preference tag, or from a default browser when the determining has a negative result; and
initiating the preferred browser.

11. The method according to claim 10, further comprising:
determining whether the at least one preference tag includes at least one identification of a preferred browser; and
determining whether one of the plurality of browsers conforms to the identification of the preferred browser, and selecting a browser conforming to the identification of the preferred browser if so.

12. The method according to claim 10, further comprising:
determining whether the at least one preference tag includes at least one requirement for handling the web page; and
determining whether one of the plurality of browsers conforms to the at least one requirement, and selecting a browser conforming to the at least one requirement if so.

13. The method according to claim 12, further comprising:
selecting a browser conforming to most of the at least one requirement, as compared to other browsers, if none of the plurality of browsers conforms to all of the at least one requirement.

14. A computer-implemented method for providing a web page service, comprising:
initializing at least one preference setting for selecting a preferred browser for a web page;
receiving a request for the web page;
embedding the at least one preference setting in the web page as a preference tag; and
returning the web page for displaying with the preferred browser.

15. The method according to claim 14, further comprising:
determining whether the requested web page is dynamically-linked, and sending a request for the web page to an application server if so; and
receiving the web page as a response from the application server.

16. The method according to claim 14, further comprising:
generating the requested web page upon receiving the request for the web page; and
wherein the embedding further comprises accessing the at least one preference setting for selecting the preferred browser for the generated web page.

17. A computer program product for providing a web service, the computer program product comprising stored code which is executable on an electronic device for:
receiving a request for a web page;
determining, from a configuration file, at least one preference setting corresponding to the web page;
embedding, in the web page as a preference tag, the at least one preference setting corresponding to the web page; and
returning the web page to the requester.
